(19) United States
(12) Patent Application Publication
(10) Pub. No.: US 2008/0278926 A1
(43) Pub. Date: Nov. 13, 2008

(54) Axial Rotational Lamp Assembly

(76) Inventor: Dion Wong, (US)

Correspondence Address: Dion Wong, PO Box 4141, San Leandro, CA, 94579, US

(21) Appl. No.: 11/747,798

(22) Filed: May 11, 2007

(51) Int. Cl. F21V 21/00; F21V 7/00

(52) U.S. Cl. 362/35; 362/368; 362/296

(57) ABSTRACT

An axial rotational lamp assembly that has multiple spectrum capability. The axial rotational lamp assembly can have more than two lamps.

### FIELD OF THE INVENTION

The present invention relates to lamp fixtures and, more particularly, to placement of multiple lamps into a fixture.

### BACKGROUND OF THE INVENTION

Lack of the ability to have more than on spectrum of light over an area covered by a fixture.

It is therefore an object of the invention to provide multiple lamps in a reflector.

It is another object of the invention to provide axial rotation of the lamps.

It is another object of the invention to provide lamps of multiple spectrum in a reflector.

It is another object of the invention to . . .

### SUMMARY OF THE INVENTION

In accordance with the present invention, there is provided an axial rotational lamp assembly that has multiple spectrum capability. The axial rotational lamp assembly can have more than two lamps.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a FIG. 1 is a perspective view of axial rotational lamp assembly;

FIG. 2 is a top view of a FIG. 2 is a top view of axial rotational lamp assembly;

FIG. 3 is a side view of a FIG. 3 is a side view of axial rotational lamp assembly; and

FIG. 4 is a detail view of a FIG. 4 is a detail view of the axial rotational lamp assembly.

For purposes of clarity and brevity, like elements and components will bear the same designations and numbering throughout the Figures.

### DESCRIPTION OF THE PREFERRED EMBODIMENT

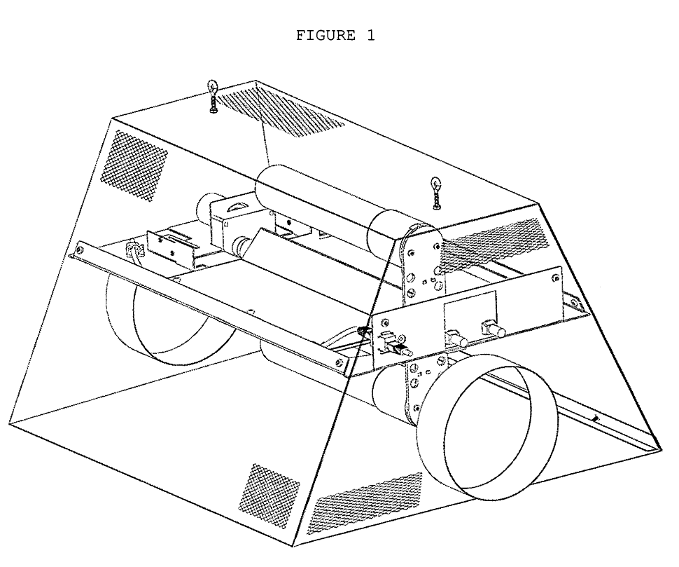

FIG. 1 is a perspective view of axial rotational lamp 8 assembly.

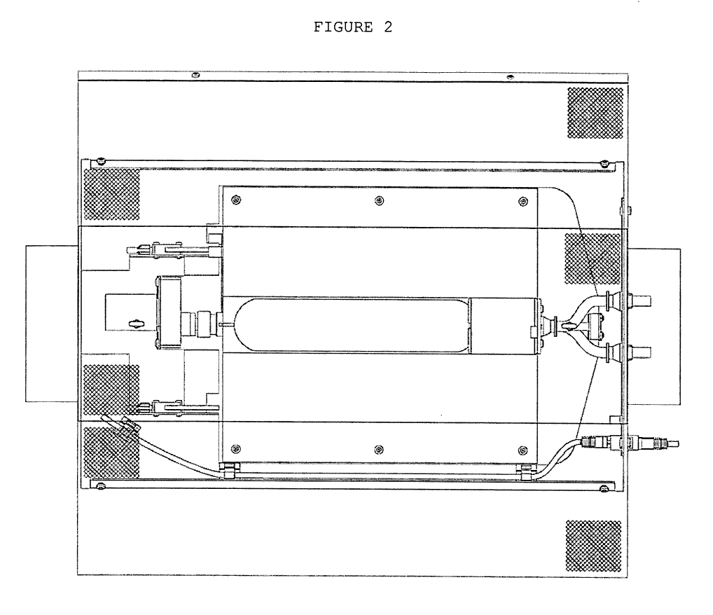

FIG. 2 is a top view of axial rotational lamp 8 assembly.

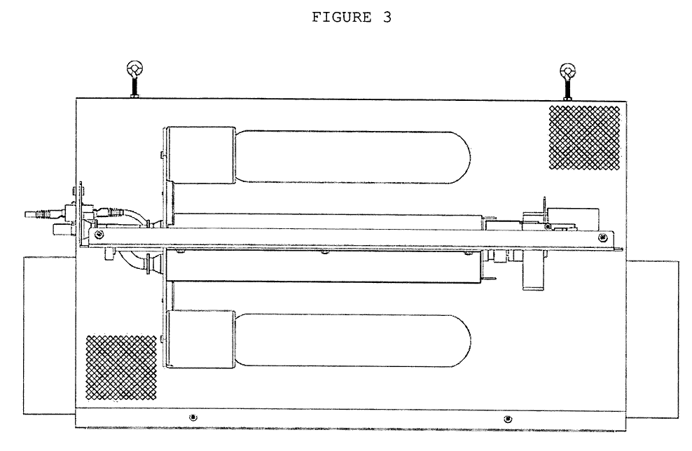

FIG. 3 is a side view of axial rotational lamp 8 assembly.

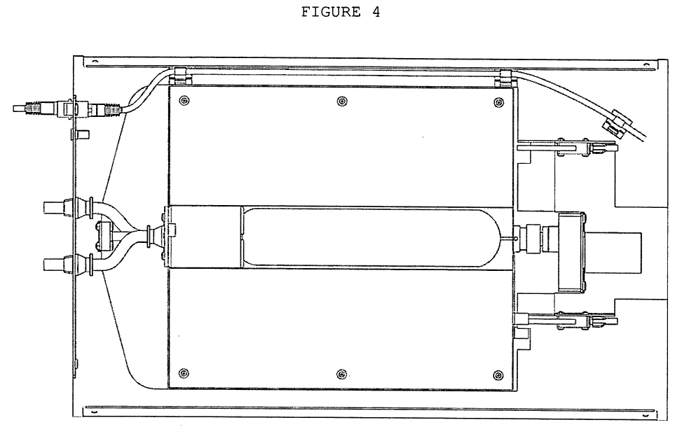

FIG. 4 is a detail view of the axial rotational lamp 8 assembly.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An axial rotational lamp assembly for an axially rotational lamp assembly for multiple lamps in a reflector, comprising:
means for housing for assembly;
means for motor to rotate assembly, subassembly encompassing to said means for housing for assembly;
means for clutch to take up motor over run after electrical disconnect and provide safety, operationally connected to said means for motor to rotate assembly;
means for limit switch to provide position information to the controlling electronics;
means for trigger arm to engage limit switch at predefined position, operationally connected to said means for limit switch to provide position information to the controlling electronics, and operationally connected to said means for motor to rotate assembly;
means for reflective plate for rflectance and cable temination housing, subassembly encompassing to said means for housing for assembly;
means for lamp;
means for socket for lamp, directly connected to said means for lamp, and subassembly encompassing to said means for housing for assembly;
means for electrical wire connecting to ballast, electrically encompassing to said means for housing for assembly;
means for bearing housing for shaft support, operationally interconnected to said means for motor to rotate assembly; and
means for control wire for motor and position status feedback to controlling electronics, elastically connected to said means for motor to rotate assembly.

2. The axial rotational lamp assembly in accordance with claim 1, wherein said means for housing for assembly comprises a new attribute 1 housing.

3. The axial rotational lamp assembly in accordance with claim 1, wherein said means for motor to rotate assembly comprises a new attribute 1 motor.

4. The axial rotational lamp assembly in accordance with claim 1, wherein said means for clutch to take up motor over run after electrical disconnect and provide safety comprises a new attribute 1 clutch.

5. The axial rotational lamp assembly in accordance with claim 1, wherein said means for limit switch to provide position information to the controlling electronics comprises a new attribute 1 limit switch.

6. The axial rotational lamp assembly in accordance with claim 1, wherein said means for trigger arm to engage limit switch at predefined position comprises a new attribute 1 trigger arm.

7. The axial rotational lamp assembly in accordance with claim 1, wherein said means for reflective plate for rflectance and cable temination housing comprises a new attribute 1 reflective plate.

8. The axial rotational lamp assembly in accordance with claim 1, wherein said means for lamp comprises a new attribute 1 lamp.

9. The axial rotational lamp assembly in accordance with claim 1, wherein said means for socket for lamp comprises a new attribute 1 socket.

10. The axial rotational lamp assembly in accordance with claim 1, wherein said means for electrical wire connecting to ballast comprises a new attribute 1 electrical wire.

11. The axial rotational lamp assembly in accordance with claim 1, wherein said means for bearing housing for shaft support comprises a new attribute 1 bearing housing.

12. The axial rotational lamp assembly in accordance with claim 1, wherein said means for control wire for motor and position status feedback to controlling electronics comprises a new attribute 1 control wire.

13. An axial rotational lamp assembly for an axially rotational lamp assembly for multiple lamps in a reflector, comprising:
a new attribute 1 housing, for housing for assembly;
a new attribute 1 motor, for motor to rotate assembly, subassembly encompassing to said Housing;
a new attribute 1 clutch, for clutch to take up motor over run after electrical disconnect and provide safety, operationally connected to said Motor;
a new attribute 1 limit switch, for limit switch to provide position information to the controlling electronics;
a new attribute 1 trigger arm, for trigger arm to engage limit switch at predefined position, operationally connected to said Limit Switch, and operationally connected to said Motor;
a new attribute 1 reflective plate, for reflective plate for rflectance and cable temination housing, subassembly encompassing to said Housing;
a new attribute 1 lamp, for lamp;
a new attribute 1 socket, for socket for lamp, directly connected to said Lamp, and subassembly encompassing to said Housing;
a new attribute 1 electrical wire, for electrical wire connecting to ballast, electrically encompassing to said Housing;
a new attribute 1 bearing housing, for bearing housing for shaft support, operationally interconnected to said Motor; and
a new attribute 1 control wire, for control wire for motor and position status feedback to controlling electronics, elastically connected to said Motor.

14. An axial rotational lamp assembly for an axially rotational lamp assembly for multiple lamps in a reflector, comprising:
a new attribute 1 housing, for housing for assembly;
a new attribute 1 motor, for motor to rotate assembly, subassembly encompassing to said Housing;
a new attribute 1 clutch, for clutch to take up motor over run after electrical disconnect and provide safety, operationally connected to said Motor;
a new attribute 1 limit switch, for limit switch to provide position information to the controlling electronics;
a new attribute 1 trigger arm, for trigger arm to engage limit switch at predefined position, operationally connected to said Limit Switch, and operationally connected to said Motor;
a new attribute 1 reflective plate, for reflective plate for rflectance and cable temination housing, subassembly encompassing to said Housing;
a new attribute 1 lamp, for lamp;
a new attribute 1 socket, for socket for lamp, directly connected to said Lamp, and subassembly encompassing to said Housing;
a new attribute 1 electrical wire, for electrical wire connecting to ballast, electrically encompassing to said Housing;
a new attribute 1 bearing housing, for bearing housing for shaft support, operationally interconnected to said Motor; and
a new attribute 1 control wire, for control wire for motor and position status feedback to controlling electronics, elastically connected to said Motor.
